(19) United States
(12) Patent Application Publication
(10) Pub. No.: US 2017/0348645 A1
(43) Pub. Date: Dec. 7, 2017

(54) POROUS SUPPORT, COMPOSITE SEMIPERMEABLE MEMBRANE AND SPIRAL WOUND SEPARATION MEMBRANE ELEMENT

(71) Applicant: NITTO DENKO CORPORATION, Osaka (JP)

(72) Inventors: Mieko NISHI, Osaka (JP); Atsuhito KOMOTO, Osaka (JP)

(73) Assignee: NITTO DENKO CORPORATION, Osaka (JP)

(21) Appl. No.: 15/533,518

(22) PCT Filed: Nov. 26, 2015
(86) PCT No.: PCT/JP2015/083169

§ 371 Date: Jun. 6, 2017

(30) Foreign Application Priority Data
Dec. 16, 2014 (JP) 2014-253799

(51) Int. Cl. B01D 69/12; B01D 71/56; B01D 67/00; C02F 1/44; B01D 63/10

(52) U.S. Cl. CPC B01D 69/125; C02F 1/44; B01D 63/10; B01D 67/0006; B01D 71/56

(57) ABSTRACT

The objective of the present invention is to provide a porous support that is unlikely to curl (the incidence of MD curling is low). This porous support has a polymer porous layer on one surface of a nonwoven cloth layer, the nonwoven cloth layer having an MD bend stiffness of 1.2 to 2.1 g·cm²/cm, and an MD bend recovery of 0.3 to 0.6 g·cm/cm. The nonwoven cloth layer is impregnated with a polymer that is the material for forming the polymer porous layer, the impregnation ratio of the polymer impregnated in the nonwoven cloth layer being 25 to 34% by weight of the total weight of the polymer in the polymer porous layer and the polymer impregnated in the nonwoven cloth layer.

### TECHNICAL FIELD

The present invention relates to a porous support having a polymer porous layer on one surface of a nonwoven cloth layer, a composite semipermeable membrane having a skin layer on the surface of the porous support, and a spiral wound separation membrane element using the composite semipermeable membrane. The composite semipermeable membrane and the spiral wound separation membrane element are suitably used for production of ultrapure water, desalination of brackish water or sea water, etc., and usable for removing or collecting pollution sources or effective substances from pollution, which causes environment pollution occurrence, such as dyeing drainage and electrodeposition paint drainage, leading to contribute to closed system for drainage. Furthermore, the membrane can be used for concentration of active ingredients in foodstuffs usage, for an advanced water treatment, such as removal of harmful component in water purification and sewage usage etc. Moreover, the membrane can be used for waste water treatment in oil fields or shale gas fields.

### BACKGROUND ART

The composite semipermeable membrane is called an RO (reverse osmosis) membrane, an NF (nanofiltration) membrane, or a FO (forward osmosis) membrane, depending on the filtration performance and treatment method of the membrane, and such membrane can be used for the production of ultrapure water, seawater desalination, desalination of brackish water, waste water recycling treatment, or the like.

As the composite semipermeable membrane, one having a skin layer formed on a porous support has been used. In addition, as the porous support, one having a polymer porous layer on one surface of a nonwoven cloth layer has been used.

The porous support can be produced by, for example, a method including applying a polymer solution (dope) for forming a polymer porous layer on a long nonwoven cloth layer, impregnating the nonwoven cloth layer having the doped membrane in a coagulation bath so that microphase separation is caused in the doped membrane, and immobilizing the porous structure of the polymer, thereby to form a polymer porous layer on the nonwoven cloth layer.

However, since the nonwoven cloth layer and the polymer porous layer have a different chemical composition and a different thermal shrinkage from each other, there has been a problem that curvature (curling) tends to easily occur at both end portions in the width direction of the prepared porous support. If curling occurs at both end portions in the width direction of the porous support, transportability deteriorates and workability deteriorates in the production of the composite semipermeable membrane. Thus, improvement in the transportability and workability has been required.

In order to solve this problem, Patent Document 1 proposes a separation membrane including an elongated fluid-permeable base and a separation layer formed on the surface of the base, wherein the separation layer includes a predetermined thickness portion having a predetermined thickness and a thinner portion positioned on the outside of each widthwise end of the predetermined thickness portion and having a thickness smaller than the predetermined thickness, and also wherein a separation-layer-lacking portion, at which only the base is present while the separation layer is absent, exists between each widthwise outer end of the thinner portion and each widthwise end of the base.

In addition, Patent Document 2 proposes a nonwoven cloth for a semipermeable membrane support, which is a nonwoven cloth containing organic synthetic fibers as a primary component, wherein a semipermeable membrane is to be supported by one surface of the nonwoven cloth and when the nonwoven cloth to be coated is separated into two layers in the thickness direction and divided into a semipermeable membrane coated side layer and a semipermeable membrane non-coated side layer, the semipermeable membrane coated side layer is 35% by mass or more and 70% by mass or less with respect to the total of the semipermeable membrane coated side layer and the semipermeable membrane non-coated side layer.

Also, the prepared porous support is stored is a state of being wound on a roll, but there has been also a problem of so-called “MD curling” that is likely to curl when rewound.

### PRIOR ART DOCUMENTS

### Patent Documents

Patent Document 1: WO2011/118486

Patent Document 2: JP-A-2013-180236

### SUMMARY OF THE INVENTION

### Problems to be Solved by the Invention

An object of the invention is to provide a porous support that is excellent in salt-rejecting property and is unlikely to curl (MD curling is less likely to occur), a composite semipermeable membrane having a skin layer on the surface of the porous support, and a spiral wound separation membrane element using the composite semipermeable membrane.

### Means for Solving the Problems

As the result of intensive studies to solve the above problems, the present inventors have found that the above problems can be solved by the following porous support and have completed the invention.

That is, the present invention relates to a porous support having a polymer porous layer on one surface of a nonwoven cloth layer, wherein the nonwoven cloth layer has an MD bend stiffness of 1.2 to 2.1 g·cm²/cm and an MD bend recovery of 0.3 to 0.6 g·cm/cm, a polymer that is a material for forming the polymer porous layer is impregnated in the nonwoven cloth laver, and the impregnation ratio of the polymer impregnated in the nonwoven cloth layer is 25 to 34% by weight of the total weight of the polymer in the polymer porous layer and the polymer impregnated in the nonwoven cloth layer.

The present inventors have found that when the porous support is unwound from the roll, a stress generated in the nonwoven cloth layer is relaxed by impregnating a polymer in an amount more than before in the nonwoven cloth layer, wherein the polymer is a material for forming a polymeric porous layer, so that a porous support which is less likely to be curled (MD curling is less likely to occur) is obtained.

As the nonwoven cloth layer, one having an MD bend stiffness of 1.2 to 2.1 g·cm²/cm and an MD bend recovery of 0.3 to 0.6 g·cm/cm is used. When the bend stiffness is less than 1.2 g·cm²/cm or when the bend recovery is less than 0.3 g·cm/cm, it is difficult to form a homogeneous polymer porous layer because wrinkles are likely to occur in the nonwoven cloth layer during line conveyance in preparing the porous support. On the other hand, since the rigidity of the nonwoven. cloth layer becomes too high or the strength of the nonwoven cloth layer itself becoming flat is weak when the bend stiffness exceeds 2.1 g·cm²/cm or when the bend recovery exceeds 0.6 g·cm/cm, processing (e.g. cutting or folding) of the composite semipermeable membrane when making the composite semipermeable membrane into an element becomes difficult, or the curling of the porous support is likely to occur even if the amount of the polymer to be impregnated in the nonwoven cloth layer is increased.

The impregnation ratio of the polymer impregnated in the nonwoven cloth layer is required to be 25 to 34% by weight of the total weight of the polymer in the polymer porous layer and the polymer impregnated in the nonwoven cloth layer. When the impregnation ratio of the polymer is less than 25% by weight, the stress generated in the nonwoven cloth layer when unwinding the porous support from the roll cannot be sufficiently relaxed, so that the porous support tends to be curled. On the other hand, when the impregnation ratio of the polymer exceeds 34% by weight, defects tend to occur in the polymer porous layer, resulting in the deterioration of the salt rejection.

The polymer is preferably a polysulfone.

Also, the present invention relates to a composite semipermeable membrane having a skin layer on the surface of the porous support, and a spiral wound separation membrane element using the composite semipermeable membrane.

### Effect of the Invention

The porous support of the invention is excellent not only in salt-rejecting property but also in uncurling tendency (MD curling is unlikely to occur), because of which the porous support has good transportability and is excellent in workability in the production of a composite semipermeable membrane.

### Mode for Carrying Out the Invention

The porous support of the invention has a polymer porous layer on one surface of a nonwoven cloth layer.

As the nonwoven cloth layer, one having an MD bend stiffness of 1.2 to 2.1 g·cm²/cm and an MD bend recovery of 0.3 to 0.6 g·cm/cm is used. The MD bend stiffness is preferably 1.3 to 2.0 g·cm²/cm and the MD bend recovery is preferably 0.35 to 0.55 g·cm/cm.

The MD bend stiffness of the nonwoven cloth layer is measured by the KES test method. Specifically, a repulsive stress when bending a nonwoven cloth layer having a length of 10 cm and a width of 10 cm in the longitudinal direction was measured using a pure bending tester, and the stress when the bending curvature was 2.5 was defined as an MD bend stiffness.

The MD bend recovery of the nonwoven cloth layer is measured by the KES test method. Specifically, repulsive stresses when bending a nonwoven cloth layer having a length of 10 cm and a width of 10 cm in the longitudinal direction and when returning the bent nonwoven cloth layer were measured using a pure bending tester, respectively, and the stress difference when the bending curvature was 2.5 was defined as an MD bend recovery (g·cm/cm).

There is employed a nonwoven cloth layer having a basis weight of preferably 65 to 95 g/m², more preferably 67 to 93 g/m², and an air permeability of preferably 0.8 to 3.5 cm³/cm²·s, more preferably 1.0 to 3.3 cm³/cm²·s so that the impregnation ratio of the polymer is adjusted to 25 to 34% by weight. Further, the thickness of the nonwoven cloth layer is preferably about 50 to 120 μm, more preferably 57 to 117 μm.

Examples of the material for the nonwoven cloth layer include polyolefin, polyester, cellulose and the like, and a mixture of a plurality of materials may be used; particularly, polyester is preferably used from the viewpoint of formability. Further, a long-fiber nonwoven cloth or a short-fiber nonwoven cloth can be used, but it is preferable to use a long-fiber nonwoven cloth from the viewpoint of little minutes fluffing causing pinhole defects and from the viewpoint of uniformity of the membrane surface.

The polymer porous layer is not particularly limited so long as the polymer porous layer can form a skin layer, but is usually a porous layer having a pore diameter of about 0.01 to 0.4 μm. The material for forming the polymer porous layer is not particularly limited, and examples thereof include polysulfone, polyarylether sulfone (e.g. polyethersulfone), polyimide, polyvinylidene fluoride, and the like; particularly, polysulfone or polyarylether sulfone is preferably used from the viewpoint of being chemically, mechanically and thermally stable.

The thickness of the polymer porous layer is not particularly limited, but if the polymer porous layer is too thick, flux will decrease. Thus, the thickness of the polymer porous layer is preferably 45 μm or less, more preferably 40 μm or less, even more preferably 35 μm or less, particularly preferably 30 μm or less. To the contrary, if the thickness of the polymer porous layer is too thin, defects tend to occur, and thus the thickness is preferably 16 μm or more, more preferably 20 μm or more.

Hereinafter, a method for producing a porous support in the case where the material for forming the polymer porous layer is a polysulfone will be described. A person skilled in the art will be able to produce the porous support of the invention by appropriately adjusting the production conditions even when the material for forming the polymer porous layer is other than the polysulfone.

The method for forming a polysulfone porous layer is not particularly limited, but such porous layer is usually formed by a wet method or a dry-wet method. For example, the polysulfone porous layer is formed on the nonwoven cloth layer by applying a polysulfone solution (dope) on a nonwoven cloth layer, and subsequently impregnating the nonwoven cloth layer having the doped membrane in a coagulation bath to cause microphase separation in the doped membrane, so that the porous structure of the polysulfone is immobilized. The polysulfone solution applied on the nonwoven cloth layer gradually penetrates the nonwoven cloth layer and the polysulfone is retained in the nonwoven cloth layer by the coagulation treatment.

Examples of the solvent used for the polysulfone solution include dimethyl suboxide, dimethylacetamide, dimethylformamide, N-methyl-2-pyrrolidone, dioxane, and the like.

The concentration of the polysulfone in the polysulfone solution is usually about 10 to 30% by weight.

From the viewpoint of adjusting the impregnation ratio of the polysulfone in the nonwoven cloth layer to 25 to 34% by weight of the total weight of the polysulfone in the polysulfone porous layer and the polysulfone impregnated in the nonwoven cloth layer, the viscosity of the polysulfone solution is preferably 500 to 10000 mPa·s, more preferably 500 to 1000 mPa·s. The method of measuring the viscosity is as described in Example.

The coating thickness of the polysulfone solution is appropriately adjusted in consideration of the amount of the polysulfone to be impregnated in the nonwoven cloth layer and the thickness of the polysulfone porous layer to be formed.

From the viewpoint of adjusting the impregnation ratio of the polysulfone in the nonwoven cloth layer to 25 to 34% by weight of the total weight of the polysulfone in the polysulfone porous layer and the polysulfone impregnated in the nonwoven cloth layer, the time from the application of the polysulfone solution onto the nonwoven cloth layer to the immobilization of the porous structure of the polysulfone is appropriately adjusted. For example, in the case of using the nonwoven cloth layer and the polysulfone solution, the time from the application of the polysulfone solution to the immobilization of the porous structure of the polysulfone is usually about 0.1 to 15 seconds.

Polysulfone is impregnated in the nonwoven cloth layer of the prepared porous support and its impregnation ratio is 25 to 34% by weight, preferably 27 to 31% by weight, relative to the total weight of the polysulfone in the polysulfone porous layer and the polysulfone impregnated in the nonwoven cloth layer.

The composite semipermeable membrane of the invention has a skin layer on the surface of the porous support.

The material for forming the skin layer is not particularly limited, and examples thereof include cellulose acetate, ethyl cellulose, polyether, polyester, polyamide, and the like.

In the invention, it is preferable that the skin layer contains a polyimide-based resin obtained by polymerizing a polyfunctional amine component and a polyfunctional acid halide component.

The polyfunctional amine component is defined as a polyfunctional amine having two or more reactive amino groups, and includes aromatic, aliphatic, and alicyclic polyfunctional amines.

The aromatic polyfunctional amines include, for example, m-phenylenediamine, p-phenylenediamine, o-phenylenediamine, 1,3,5-triamino benzene, 1,2,4-triamino benzene, 3,5-diaminobenzoic acid, 2,4-diaminotoluene, 2,6-diaminotoluene N,N-dimethyl-m-phenylenediamine, 2,4-diaminoanisole, amidol, xylylene diamine etc.

The aliphatic polyfunctional amines include, for example, ethylenediamine, propylenediamine, tris (2-aminoethyl)amine, n-phenylethylenediamine, etc.

The alicyclic polyfunctional amines include, for example, 1,3-diaminocyolohexane, 1,2-diaminocyclohexane, 1,4-diaminocyclohexane, piperazine, 2,5-dimethylpiperazine, 4-aminomethyl piperazine, etc.

These polyfunctional amines may be used independently, and two or more kinds may be used in combination. In order to obtain a skin layer having a higher salt-rejecting property, it is preferred to use the aromatic polyfunctional amines.

The polyfunctional acid halide component represents polyfunctional acid halides having two or more reactive carbonyl groups.

The polyfunctional acid halides include aromatic, aliphatic, and alicyclic polyfunctional acid halides.

The aromatic polyfunctional acid halides include, for example trimesic acid trichloride, terephthalic acid dichloride, isophthalic acid dichloride, biphenyl dicarboxylic acid dichloride, naphthalene dicarboxylic acid dichloride, benzenetrisulfonic acid trichloride, benzenedisulfonic acid dichloride, chlorosulfonyl benzenedicarboxylic acid dichloride etc.

The aliphatic polyfunctional acid halides include, for example, propanedicarboxylic acid dichloride, butane dicarboxylic acid dichloride, pentanedicarboxylic acid dichloride, propane tricarboxylic acid trichloride, butane tricarboxylic acid trichloride, pentane tricarboxylic acid trichloride, glutaryl halide, adipoyl halide etc.

The alicyclic polyfunctional acid halides include, for example, cyclopropane tricarboxylic acid trichloride, cyclobutanetetracarboxylic acid tetrachloride, cyclopentane tricarboxylic acid trichloride, cyclopentanetetracarboxylic acid tetrachloride, cyclohexanetricarboxylic acid trichloride, tetrahydrofurantetracarboxylic acid tetrachloride, cyclopentanedicarboxylic acid dichloride, cyclobutanedicarboxylic acid dichloride, cyclohexanedicarboxylic acid dichloride, tetrahydrofuran dicarboxylic acid dichloride, etc.

These polyfunctional acid halides may be used independently and two or more kinds may be used in combination. In order to obtain a skin layer having higher salt-rejecting property, it is preferred to use aromatic polyfunctional acid halides. In addition, it is preferred to form a cross linked structure using polyfunctional acid halides having trivalency or more as at least a part of the polyfunctional acid halide components.

Furthermore, in order to improve performance of the skin layer including the polyamide-based resin, polymers such as polyvinyl alcohol, polyvinylpyrrolidone, and polyacrylic acids etc., and polyhydric alcohols, such as sorbitol and glycerin, may be copolymerized.

Processes for forming the skin layer including the polyamide-based resin on the surface of the porous support is not in particular limited, and any publicly known methods may be used. For example, the publicly known methods include an interfacial condensation method, a phase separation method, a thin film application method, etc. The interfacial condensation method is a method, wherein an amine aqueous solution containing a polyfunctional amine component, an organic solution containing a polyfunctional acid halide component are forced to contact together to form a skin layer by an interfacial polymerization, and then the obtained skin layer is laid on a porous support, and a method wherein a skin layer of a polyamide-based resin is directly formed on a porous support by the above-described interfacial polymerization on a porous support. Details, such as conditions of the interfacial condensation method, are described in Japanese Patent Application Laid-Open. No. S58-24303, Japanese Patent Application Laid-Open No. H01-180208, and these known methods are suitably employable.

In the present invention, it is preferred to form a skin layer by an interfacial polymerization method including forming a coating layer of an aqueous solution containing a polyfunctional amine component on a porous support and bringing an organic solution containing a polyfunctional acid halide component into contact with the coating layer of the aqueous solution.

In the interfacial polymerization method, although the concentration of the polyfunctional amine component in the amine aqueous solution is not in particular limited, the concentration is preferably 0.1 to 5% by weight, and more preferably 0.5 to 3% by weight. Less than 0.1% by weight of the concentration of the polyfunctional amine component may easily cause defect such as pinhole in the skin layer, leading to tendency of deterioration of salt-rejecting property. On the other hand, the concentration of the polyfunctional amine component exceeding 5% by weight allows to be an excessively large thickness and to raise the permeation resistance, likely giving deterioration of the permeation flux.

Although the concentration of the polyfunctional acid halide component in the organic solution is not in particular limited, it is preferably 0.01 to 5% by weight, and more preferably 0.05 to 3% by weight. Less than 0.01% by weight of the concentration of the polyfunctional acid halide component is apt to make the unreacted polyfunctional amine component remain, to cause defect such as pinhole in the skin layer, leading to tendency of deterioration of salt-rejection property. On the other hand, the concentration exceeding 5% by weight of the polyfunctional acid halide component is apt to make the unreacted polyfunctional acid halide component remain, to be an excessively large thickness and to raise the permeation resistance, likely giving deterioration of the permeation flux.

The organic solvents used for the organic solution is not especially limited as long as they have small solubility to water, and do not cause degradation of the porous support, and dissolve the polyfunctional acid halide component. For example, the organic solvents include saturated hydrocarbons, such as cyclohexane, heptane, octane, and nonane, halogenated hydrocarbons, such as 1,1,2-trichlorofluoroethane, etc. The organic solvent is preferably a saturated hydrocarbon having a boiling point of 300° C. or less, more preferably a saturated hydrocarbon having a boiling point of 200° C. or less.

Various kinds of additives may be added to the amine aqueous solution or the organic solution in order to provide easy film production and to improve performance of the composite semipermeable membrane to be obtained. The additives include, for example, surfactants, such as sodium dodecylbenzenesulfonate, sodium dodecyl sulfate, and sodium lauryl sulfate; basic compounds, such as sodium hydroxide, trisodium phosphate, triethylamine, etc. for removing hydrogen halides formed by polymerization; acylation catalysts; compounds having a solubility parameter of 8 to 14 (cal/cm³)^{1/2} described in Japanese Patent Application Laid-Open No. H08-224452.

The period of time after application of the amine aqueous solution until application of the organic solution on the porous support depends on the composition and viscosity of the amine aqueous solution, and on the pore size of the surface of the porous support, and it is preferably 15 seconds or less, and more preferably 5 seconds or less. Application interval of the solution exceeding 15 seconds may allow permeation and diffusion of the amine aqueous solution to a deeper portion in the porous support, and possibly cause a large amount of the residual unreacted polyfunctional amine components in the porous support. In this case, removal of the unreacted polyfunctional amine component that has permeated to the deeper portion in the porous support is probably difficult even with a subsequent membrane washing treatment. Excessive amine aqueous solution may be removed after covering by the amine aqueous solution on the porous support.

In the present invention, after the contact with the coating layer of amine aqueous solution and the organic solution, it is preferred to remove the excessive organic solution on the porous support, and to dry the formed membrane on the porous support by heating at a temperature of 70° C. or more, forming the skin layer. Heat-treatment of the formed membrane can improve the mechanical strength, heat-resisting property, etc. The heating temperature is more preferably 70 to 200° C., and especially preferably 100 to 150° C. The heating period of time is preferably approximately 30 seconds to 10 minutes and more preferably approximately 40 seconds to 7 minutes.

The thickness of the skin layer is not in particular limited, and it is usually approximately 0.05 to 2 μm, and preferably 0.1 to 1 μm.

There is no limitation on the shape of the composite semipermeable membrane of the present invention. That is, the composite semipermeable membrane can take any conceivable membrane shapes, such as a flat membrane or a spiral element. Further, conventionally known various treatments may be applied to the composite semipermeable membrane so as to improve its salt-rejecting property, water permeability, and oxidation resistance.

The spiral wound separation membrane element of the present invention is produced, for example, by stacking a permeate spacer onto a material obtained by disposing a feed spacer between two sheets of a two-folded composite semipermeable membrane; applying an adhesive on the composite semipermeable membrane peripheral parts (three sides) so as to form sealing parts for preventing the feed-side fluid and the permeation-side fluid from being mixed with each other, thereby to prepare a separation membrane unit; winding one of the unit or a plurality of the units in a spiral form around a core tube, and further sealing the separation membrane unit peripheral parts.

### EXAMPLE

The present invention will, hereinafter, be described with reference to Examples, but the present invention is not limited at all by these Examples.

[Evaluation and Measurement Method]

(Measurement of MD Bend Stiffness of Nonwoven Cloth Layer)

KES test method; Using a pure bending tester (KES-FB2, manufactured by Kato Tech Co., Ltd.), a repulsive stress was measured when a nonwoven cloth layer having a length of 10 cm and a width of 10 cm was bent in the longitudinal direction, and the stress when the bending curvature was 2.5 was defined as a bend stiffness (g·cm²/cm).

(Measurement of MD Bend Recovery in Nonwoven Cloth Layer)

KES test method; Using a pure bending tester (KES-FB2, manufactured by Kato Tech Co., Ltd.) repulsive stresses when bending a nonwoven cloth layer having a length of 10 cm and a width of 10 cm in the longitudinal direction and when returning the bent nonwoven cloth layer were measured, respectively, and the stress difference when the bending curvature was 2.5 was defined as a bend recovery (g·cm/cm)

(Measurement of Air Permeability of Nonwoven Cloth Layer)

In accordance with the method described in JIS L 1096, the air permeability of the nonwoven cloth layer was measured using a Frazier type tester.

(Measurement of Viscosity of Polysulfone Solution)

The viscosity of the polysulfone solution was measured at a measurement temperature of 30° C. using an E type viscometer (RE-85 type viscometer, manufactured by Toki Sangyo Co., Ltd.).

(Calculation of impregnation Ratio of Polysulfone Impregnated in Nonwoven Cloth Layer)

The weight A of the dried porous support was measured. Thereafter, the polysulfone porous layer was peeled off from the porous support with a tape, and the weight B of the nonwoven cloth layer was measured. Then, the nonwoven cloth layer was impregnated in DMF, and the polysulfone impregnated in the nonwoven cloth layer was dissolved in DMF. Subsequently, the nonwoven cloth layer was taken out from the DMF, washed, and dried. Then, the weight C of the nonwoven cloth layer was measured.

The weight D of the polysulfone porous layer was calculated by the following formula:

Weight D=Weight A−Weight B

The weight E of the polysulfone impregnated in the nonwoven cloth layer was calculated by the following formula:

Weight B=Weight B−Weight C

The impregnation ratio (% by weight) of the polysulfone impregnated in the nonwoven cloth layer was calculated by the following formula:

Impregnation ratio (% by weight)=[Weight E/(Weight D+Weight E)]×100

(Measurement of Salt-Rejection)

The prepared flat shape composite semipermeable membrane was cut into a predetermined shape and size, and was set to a cell for flat shape evaluation. An aqueous solution containing 0.15 wt % NaCl and being adjusted to pH 6.5 was allowed to contact to a supply side and permeation side of the membrane at a differential pressure of 1.5 MPa at 25° C. An electric conductivity of the permeated water obtained by this operation was measured, and a salt-rejection (%) was calculated. The correlation (calibration curve) of the NaCl concentration and electric conductivity of the aqueous solution was made beforehand, and the salt-rejection was calculated by the following equation.

Salt-rejection (%)={1−(NaCl concentration in permeated liquid [mg/L])/(NaCl concentration in supply solution) [mg/L]}×100

(Evaluation of MD Curling of Porous Support)

The prepared porous support was unwound from the supply roll and cut into a size of 1 m in width and 1 m in length to obtain a sample. The sample was placed on a flat table and the warpage height from the table at the end portion in the MD direction was measured and the MD curling of the porous support was evaluated in accordance with the following criteria:

⊙: The warpage height is 20 mm or less.
◯: The warpage height is from more than 20 mm to 26 mm or less.
x: the warpage height is more than 26 mm.

### Example 1

A polysulfone solution (dope) containing 18.3% by weight of polysulfone and dimethylformamide was coated on the surface of a nonwoven cloth layer shown in Table 1, and then the nonwoven cloth layer having the doped membrane was impregnated in a water bath to be coagulated, so that a polysulfone porous layer having a thickness of 20 μm was formed to prepare a porous support, and the produced porous support was wound around a supply roll. The time from the application of the polysulfone solution to the completion of the coagulation treatment was 3.6 seconds.

Then, an amine solution was prepared by dissolving 3% by weight of metaphenylene diamine in water. In addition, 0.25% by weight of trimesic acid chloride was dissolved in hexane to prepare an organic solution. While delivering the produced porous support from the supply roll, the amine solution was coated on the porous support, and then the excess amine solution was removed to form an amine solution coating layer. Next, the organic solution was coated on the surface of the amine solution coating layer. Thereafter, the excessive solution was removed and the coating layer was further kept in a hot air dryer at 140° C. for 3 minutes to form a skin layer containing a polyamide-based resin on the porous support, thereby to prepare a composite semipermeable membrane.

### Example 2

A polysulfone solution (dope) containing 18.3% by weight of polysulfone and dimethylformamide was coated on the surface of a nonwoven cloth layer shown in Table 1, and then the nonwoven cloth layer having the doped membrane was impregnated in a water bath to be coagulated, so that a polysulfone porous layer having a thickness of 20 μm was formed to prepare a porous support, and the produced porous support was wound around the supply roll. The time from the application of the polysulfone solution to the completion of the coagulation treatment was 3.5 seconds.

Then, a composite semipermeable membrane was prepared in the same manner as in Example 1.

### Example 3

A polysulfone solution (dope) containing 18.3% by weight of polysulfone and dimethylformamide was coated on the surface of a nonwoven cloth layer shown in Table 1, and then the nonwoven cloth layer having the doped membrane was impregnated in a water bath to be coagulated, so that a polysulfone porous layer having a thickness of 20 μm was formed to prepare a porous support, and the produced porous support was wound around the supply roll. The time from the application of the polysulfone solution to the completion of the coagulation treatment was 3.4 seconds.

Then, a composite semipermeable membrane was prepared in the same manner as in Example 1.

### Example 4

A polysulfone solution (dope) containing 18.3% by weight of polysulfone and dimethylformamide was coated on the surface of a nonwoven cloth layer shown in Table 1, and then the nonwoven cloth layer having the doped membrane was impregnated in a water bath to be coagulated, so that a polysulfone porous layer having a thickness of 30 μm was formed to prepare a porous support, and the produced porous support was wound around the supply roll. The time from the application of the polysulfone solution to the completion of the coagulation treatment was 3.3 seconds.

Then, a composite semipermeable membrane was prepared in the same manner as in Example 1.

### Comparative Example 1

A polysulfone solution (dope) containing 18.3% by weight of polysulfone and dimethylformamide was coated on the surface of a nonwoven cloth layer shown in Table 1, and then the nonwoven cloth layer having the doped membrane was impregnated in a water bath to be coagulated, so that a polysulfone porous layer having a thickness of 15 μm was formed to prepare a porous support, and the produced porous support was wound around the supply roll. The time from the application of the polysulfone solution to the completion of the coagulation treatment was 3.7 seconds.

Then, a composite semipermeable membrane was prepared in the same manner as in Example 1.

### Comparative Example 2

A polysulfone solution (dope) containing 18.3% by weight of polysulfone and dimethylformamide was coated on the surface of a nonwoven cloth layer shown in Table 1, and then the nonwoven cloth layer having the doped membrane was impregnated in a water bath to be coagulated, so that a polysulfone porous layer having a thickness of 30 μm was formed to prepare a porous support, and the produced porous support was wound around the supply roll. The time from the application of the polysulfone solution to the completion of the coagulation treatment was 3.2 seconds.

Then, a composite semipermeable membrane was prepared in the same manner as in Example 1.

TABLE 1

| | | | | | Comparative | Comparative |
|---|---|---|---|---|---|---|
| | Example 1 | Example 2 | Example 3 | Example 4 | Example 1 | Example 2 |
| Material for nonwoven cloth layer | Polyester | Polyester | Polyester | Polyester | Polyester | Polyester |
| MD bend stiffness of nonwoven cloth layer (g · cm²/cm) | 1.80 | 1.89 | 1.61 | 1.32 | 1.80 | 1.44 |
| MD bend recovery of nonwoven cloth layer (g · cm/cm) | 0.52 | 0.45 | 0.32 | 0.4 | 0.52 | 0.27 |
| Basis weight of nonwoven cloth layer (g/m²) | 77 | 81 | 80 | 83 | 77 | 74 |
| Air permeability of nonwoven cloth layer (cm³/cm² · s) | 3.1 | 1.5 | 2.1 | 2.0 | 3.1 | 1.7 |
| Thickness of nonwoven cloth layer (μm) | 120 | 103 | 102 | 101 | 120 | 96 |
| Viscosity of polysulfone solution (mPa · s) | 600-850 | 600-850 | 600-850 | 600-850 | 600-850 | 600-850 |
| Impregnation ratio of polysulfone (% by weight) | 34 | 30 | 28 | 25 | 37 | 23 |
| Salt-rejection (%) | 99.8 | 99.8 | 99.7 | 99.7 | 99.5 | 99.7 |
| MD curling | ○ | ⊙ | ⊙ | ○ | ○ | × |

### INDUSTRIAL APPLICABILITY

The composite semipermeable membrane and spiral wound separation membrane element of the present invention are suitably used for production of ultrapure water, desalination of brackish water or sea water, etc., and usable for removing or collecting pollution sources or effective substances from pollution, which causes environment pollution occurrence, such as dyeing drainage and electrodeposition paint drainage, leading to contribute to closed system for drainage. Furthermore, the element can be used for concentration of active ingredients in foodstuffs usage, for an advanced water treatment, such as removal of harmful component in water purification and sewage usage etc. Moreover, the element can be used for waste water treatment in oil fields or shale gas fields.

1. A porous support having a polymer porous layer on one surface of a nonwoven cloth layer, wherein the nonwoven cloth layer has an MD bend stiffness of 1.2 to 2.1 g·cm²/cm and an MD bend recovery of 0.3 to 0.6 g·cm/cm, a polymer that is a material for forming the polymer porous layer is impregnated in the nonwoven cloth layer, and the impregnation ratio of the polymer impregnated in the nonwoven cloth layer is 25 to 34% by weight of the total weight of the polymer in the polymer porous layer and the polymer impregnated in the nonwoven cloth layer.

2. The porous support according to claim 1, wherein the polymer is a polysulfone.

3. A composite semipermeable membrane having a skin layer on the surface of the porous support according to claim 1.

4. A spiral wound separation membrane element using the composite semipermeable membrane according to claim 3.

5. A composite semipermeable membrane having a skin layer on the surface of the porous support according to claim 2.

6. A spiral wound separation membrane element using the composite semipermeable membrane according to claim 5.
